(19) United States
(12) Patent Application Publication
(10) Pub. No.: US 2007/0162472 A1
(43) Pub. Date: Jul. 12, 2007

(54) MULTI-DIMENSIONAL DATA ANALYSIS

(75) Inventors: Qiang Wan, Bellevue, WA (US); Ping Luo, Woodinville, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: SEATAB SOFTWARE, INC., Bellevue, WA (US)

(21) Appl. No.: 11/616,240

(22) Filed: Dec. 26, 2006

Related U.S. Application Data
(60) Provisional application No. 60/754,014, filed on Dec. 23, 2005.

(51) Int. Cl. G06F 7/00

(52) U.S. Cl. 707/100

(57) ABSTRACT

A system and method for generating a multi-dimensional data structures are provided. One or more data sources including data formats are obtained. Based on data processing requirements, a multi-dimensional data structured is developed and processing definitions for the source data is developed including the alignment of data attributes and the definition of metric calculations. Thereafter, the source data may be queried using the definitions. Additionally, the data definitions may be dynamically modified without requiring the modification of the source data.

### CROSS-REFERENCE TO RELATED APPLICATION

This application claims the benefit of U.S. Provisional Application No. 60/754,014, filed Dec. 23, 2005, incorporated herein by reference.

### BACKGROUND

Generally described, computing devices, such as server computing devices, can be utilized to process data. In one business related example, server computing devices include a business software application can be used to collect and process business data. The business data can correspond to an initial set of data calculations that is often referred to as “measures,” “metrics,” “key performance indications (KPI),” and “aggregates.” The business software application can provide users with access to processed business data in a manner that can be used to model or track business activity (e.g., sales by region/store, etc.) Typically, the business software application allows users to query the initial set of business data and/or request additional information about the collected/processed business data. The ability to request additional information about underlying business data is often referred to as “drilling down” into the data. Further, the specific link structure of the underlying data that is used to provide users with the additional information is typically referred to as the “drill path.”

To provide users with varied access to business data, many business applications utilize a multi-dimensional data structure that corresponds to a set of drill paths, or dimensions. One typical embodiment of a multi-dimensional data structure is a “star schema” that corresponds to a data structure having a set of predefined drill paths, or dimensions. FIG. 1 is a block diagram illustrative of a data schema 100 for storing and processing business related information. The data schema 100 is configured as base fact table and a series of linked master tables, which is commonly referred to as a star schema. For illustrative purposes, the data schema 100 corresponds to sales transaction data obtained from a seller from one or more databases. As illustrated in FIG. 1, the data schema 100 includes a base fact table 102 that includes a first section 104 identifying underlying data and a second section 106 identifying additional data processed from underlying data.

With continued reference to FIG. 1, each entry in the first section 104 includes a link to a master table that defines the drill path, or dimension, for additional details for the business information. For example, the customer ID field in the central fact table 102 corresponds to a link to a customer master table 108 that identifies various levels of detail about a customer and a drill path 110 for the way customer information is delivered to a user. Similarly, the product ID field in the central fact table 102 corresponds to a link to a product master table 112 and drill path 114, the sale rep ID field corresponds to a link to a sales rep master table 116 and drill path 118 and the day field includes a link to a time master table 120 and drill path 122. Each data schema 100 is typically referred to as a “cube.” In a more complex example, multiple data schemas, or cubes, can be incorporated such that drill paths can be defined across multiple schemas, referred to generally as “drilled across.”

In accordance with the typical embodiment with star schema, such a schema 100, or a multi-dimensional schema, data is collected from a business from various sources, generally referred to as source data. Based on a predetermined need, the structure of the schema and available drill paths is determined and predefined. A computing device then attempts to store the collected data in the manner defined in the schema. If the incoming data cannot be associated, or otherwise processed, into one of the defined tables of the schema, the system must further process the source data to obtain the desired data or otherwise discard the data. The further processing typically corresponds to a data transformation, in the form of normalization, that modifies the underlying business data into a manner dictated by the structure defined for the schema. For example and with reference to FIG. 1, in a typical data processing scenario, up to 80% of incoming data must be processed or otherwise discarded. Once the data is collected and processed, all data queries must be processed according to the various defined drill paths 110, 114, 118, and 120. Absent a reconfiguration of the tables and their relationships, users have no mechanism for adding data fields to be considered and/or varying the drill path of the collected/processed data. Typically, this would require the configuration of an additional schema cube. Accordingly, star schema data processing systems do not provide an extensible framework for analyzing data.

Based on the above-described deficiencies, there is a need for a system and method for establishing a dynamic and extensible data processing framework.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A system and method for generating a multi-dimensional data structures are provided. One or more data sources including data formats are obtained. Based on data processing requirements, a multi-dimensional data structured is developed and processing definitions for the source data is developed including the alignment of data attributes and the definition of metric calculations. Thereafter, the source data may be queried using the definitions. Additionally, the data definitions may be dynamically modified without requiring the modification of the source data.

In accordance with an aspect of the invention, a method for managing data is provided. A data processing application obtains obtaining a set of source data. The set of source data can correspond to a native format. The data processing application then identifies a set of data requirements and defines a set of data definitions corresponding to the processing of the source data to obtain the set of data requirements. The data processing application then stores the set of data definitions.

In accordance with another aspect of the invention, a computer-readable medium having computer-executable components for data management is provided. The components include an interface for obtaining a set of data sources. The set of data sources source data can correspond to a native format. The components also include a data processing component for identifying a set of data requirements and processing of the source data to obtain the set of data requirements. The components further include a second interface for obtaining data queries for the processed source data.

In accordance with a further aspect of the invention, a method for managing data is provided. A data processing application obtains obtaining a set of source data. The set of source data can correspond to a native format. The data processing application then identifies a set of data requirements and defines a set of data definitions corresponding to the processing of the source data to obtain the set of data requirements. Thereafter, the data processing application obtains a data query and provides a set of data corresponding to the data query. Additionally, the data processing application obtains a revised data query based on drill paths.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrative of conventional data schemas for storing data;

FIG. 2 is a block diagram illustrative of a system for data management of source data and data query processing in accordance with aspects of the present invention;

FIG. 3 is the block diagram of FIG. 2 illustrating a data management interface in accordance with the present invention;

FIG. 4 is the block diagram of FIG. 2 illustrating a data query interface with another computing device in accordance with the present invention; and

FIG. 5 is a flow diagram illustrative of a data management routine implemented in accordance with an aspect of the present invention;

FIG. 6 is a block diagram illustrating the association of attribute data from source data in accordance with an aspect of the present invention;

FIG. 7 is a block diagram illustrating the alignment of data attributes and merging of metrics to generate a pool of attributes and data metrics in accordance with an aspect of the present invention;

FIG. 8 is a flow diagram illustrative of a data query processing routine implemented in accordance with the present invention; and

FIG. 9 is a block diagram illustrating the generation of drill paths in accordance with an aspect of the present invention.

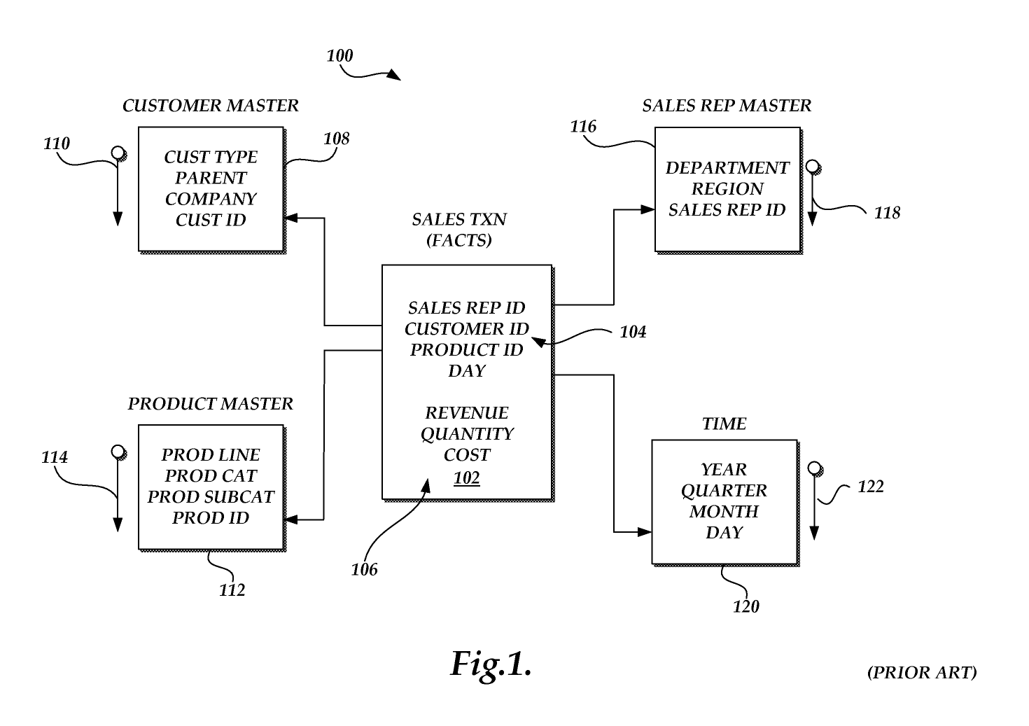

### DETAILED DESCRIPTION

Generally described, the present application is directed toward a system and method for delivering multi-dimensional data analysis. In particular, the present application relates to a system and method for providing a flexible and dynamic multi-dimensional data framework in which data dimensions can be modified, added, and removed without requiring data transformation and/or reconfiguration of underlying data structures. The framework utilizes a set of logical drill paths that are based of aligned and merged data attributes and data metrics. Although the present invention will be described with illustrative business data and examples, one skilled in the relevant art will appreciate that the disclosed embodiments are illustrative and should not be construed as limiting.

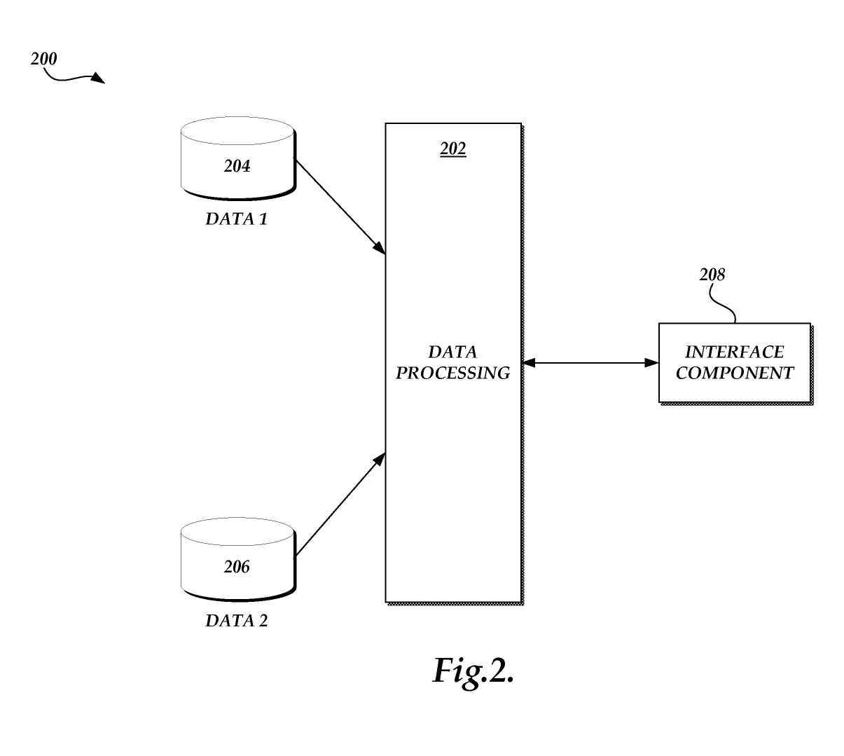

With reference now to FIGS. 2-4, a sample system 200 for processing source data and/or data queries will be described. With reference to FIG. 2, the system 200 includes a data processing interface 202 for processing source data and receiving data queries. In one aspect, the data processing interface 202 includes various components for obtaining data from various data sources, obtaining data management information from user computing devices, and processing source data to generate a data pool. The processing of data from various resources will be described in greater detail below. In another aspect, the data processing interface 203 includes various components for processing data queries and modifying data queries according to drill paths. The processing of data queries will be described in greater detail below. One skilled in the relevant art will appreciate that the data processing interface 202 may include any number of computing devices for performing the various functions associated with the data processing interface 202. The computing devices can include, but are not limited to, personal computing devices, server computing devices, terminal computing devices, and the like. Additionally, although the data processing interface 202 is illustrated as a component, one skilled in the relevant art will appreciate that the data processing interface 202 may be provided in the form of a software service provided over a network connection, such as the Internet.

The system 200 also includes a number of data sources 204, 206 for providing source data in a native format. In an illustrative embodiment, the data sources 204, 206 can be provided by third parties, such as customers or other data providers. As will be described in greater detail below, the source data does not need to be copied and/or stored with the system 200. Alternatively, some or a portion of the source data may be processing, copies and/or stored. The source data may be provided in any one of a variety of data formats, such as a native data format, or processed in some manner for the system 200. Additionally, the source data may be provided to the system 200 in a variety of manners including batch data transfer, continuous data feeding, streaming, and the like. Further, the source data may be synchronously or asynchronously provided.

With continued reference to FIG. 2, the system 200 also includes one or more interface components 208 for interfacing with the data processing component 202. The interface component 208 may be embodied as a software component on a user computing device. The interface component 208 may be a stand alone software component or integrated as a component to another software application, such as a browser software application. The interface component 208 may communicate with the data processing component 202 via a network connection such as the Internet or a local network connection. One skilled in the relevant art will appreciate that the interface component 208 may be utilized in any one of a variety of computing devices, such as personal computing devices, handheld computing devices, mobile communication devices, server computing devices, and the like.

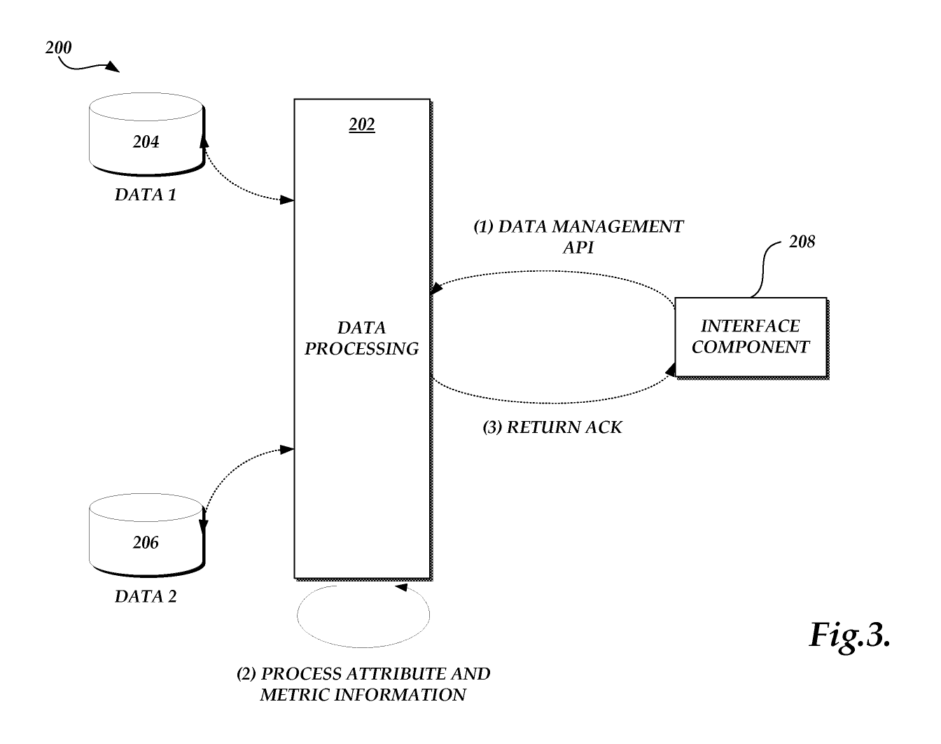

With reference now to FIG. 3, in an illustrative embodiment, the interface component 208 may be utilized to initiate the configuration of source data. As illustrated in FIG. 3, the interface component 208 can utilize a data management application protocol interface (API) to initiate the processing of source data. In an illustrative embodiment, the API may defined the location of the source data, the native format of the source data, an initial definition of the information to be obtained from the source data, and the definition of the outputs to be generated by the data processing application 202. Based upon the information provided by the API, the data processing application 202 processes the source data from one or more data sources, such as data sources 204, 206, to generate the structure of the attribute data and metric data to be generated. The data processing application then processes the source data to obtain the specifics of the attribute derivation, attribute alignment, metric merging and metric derivation. The data processing application 202 can then generate an acknowledgement to the interface application 208. Thereafter, the source data may be processed according to the definitions provided by the data processing application 202. In an illustrative embodiment, the processing of the source data according to the definitions may occur synchronously with the completion of the definitions or alternatively, upon another event (e.g., receipt of a data query). The processing of the source data according to the definitions may include one or more additional data components, such as a data processing engine (not shown).

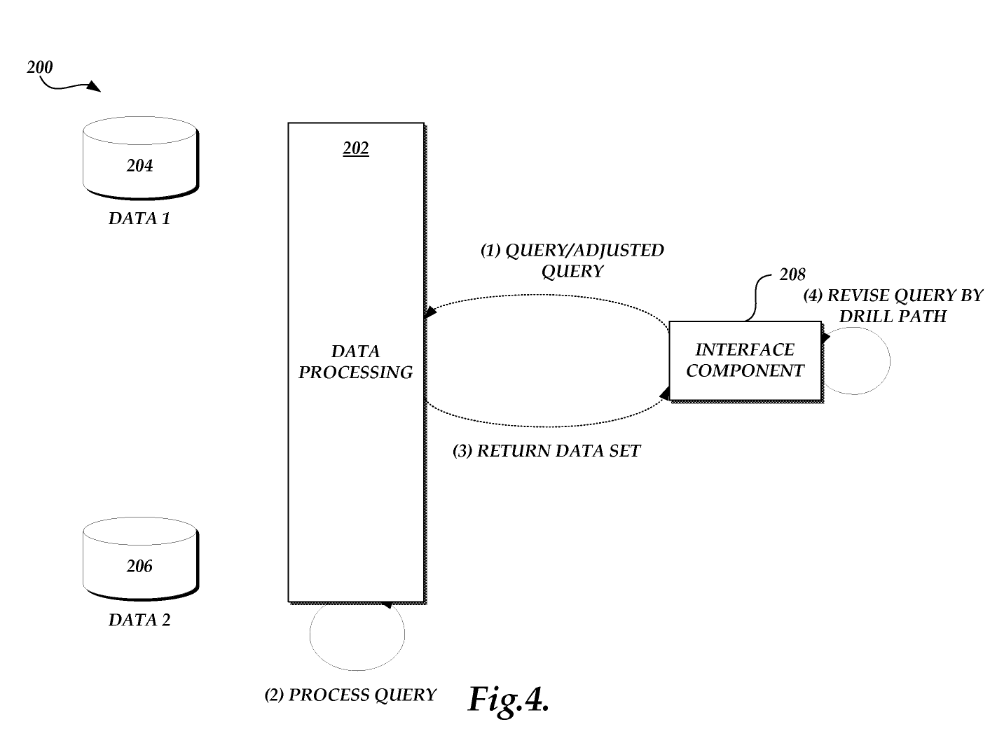

With reference now to FIG. 4, in another aspect, the interface component 208 may be utilized to process a data query. As illustrated in FIG. 4, the interface component 208 transmit an initial data query that includes information for defining data to be returned. In an illustrative embodiment, the data query can include field definitions, value ranges, keywords, and the like. The data query can then be processed according to the underlying source data and the definitions previously provided by the data processing application 202 (FIG. 3). A resulting data set can be returned to the interface component 208. Thereafter, a modified data query may be provided by the interface component 208 according to drill paths for the processed source data and the process repeats. In an illustrative embodiment, in the event that the drill path selected by the modified data query has not previously been defined, the data processing application 202 may process the source data again to generate new attribute and metric definitions/derivations/calculations according to the new defined drill path.

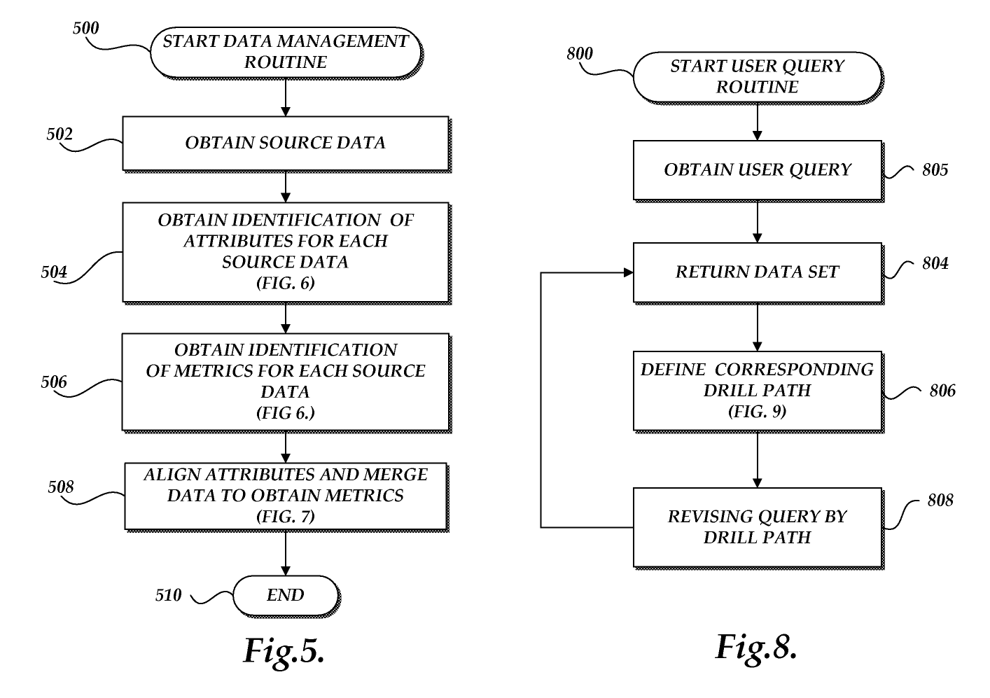

With reference now to FIG. 5, a flow diagram illustrative of a data management routine 500 implemented in accordance with the present invention will be described. In accordance with the routine, at block 502, the data processing application 202 obtains source data that originate from a plurality of data sources, such as data sources 204, 206. In an illustrative embodiment of the present invention, the source data can correspond to data in a native format as provided by the data source. In an alternative embodiment, the source data can also correspond to data that has been processed in some manner from its native format, but which has not yet been configured for use with a particular multi-dimensional data structure. Additionally, in an illustrative embodiment, a copy of the source data can be obtained and stored. Alternatively, the source may be obtained by referencing pointers to a pre-existing source or function calls for streaming the source data.

At block 504, the data processing application 202 obtains the attribute data from the source data and calculates any derived attributes. In an illustrative embodiment, as described above, obtaining the attribute data can correspond to identifying a pointer, or other reference, to the source data. In an alternative embodiment, obtaining the attribute data can correspond to obtaining a copy of a set of attribute data from the source data or from a copy of the source data. In another aspect, attribute data may also be derived from the source. For example, information from a data source may correspond to daily transaction data. In accordance with the illustrative example, the derived attributes of the transaction could then correspond to other time based calculations, such as weekly records, quarterly records, yearly records, and the like. In an illustrative embodiment, the derived attribute data may be processed and stored by the interface application. Alternatively, the interface application may determine the necessary calculations for the derived data and will defer the calculation of the derived data until the derived data is required.

At block 506, the interface application obtains a definition of metric data from each source data according to the multi-dimensional data structure. In an illustrative embodiment, the identification of attribute data and source data may correspond to the definition of a set of attributes common to different data sources. Additionally, the metric information may calculations that have been defined as a requirement for the processing of the source data. In an illustrative embodiment, the metric data and attribute data do not have to be pre-calculated and/or stored. Rather, the interface application determines the attribute and metric information that will be needed without having to conduct the pre-calculation. Accordingly, some or a portion of the processing of metric data and derived attributes may be calculated in real-time or substantial real time with the processing a data query, as will be described in greater detail below.

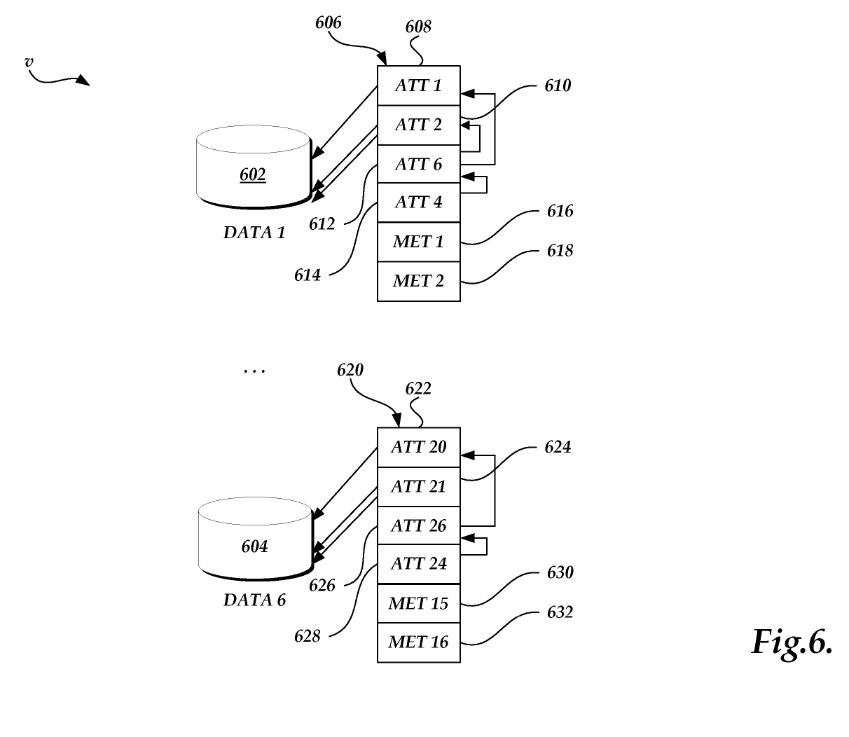

FIG. 6 is a block diagram 600 illustrating the association of attribute data and metric data from data sources 602, 604 in accordance with an aspect of the present invention. As illustrated in FIG. 6, a set of attribute data 606, 620 can be provided or otherwise obtained from each data source 602, 604. Each set can include one or more attributes, such as attributes 608-610 for source 602 and attributes 622-626 for source 604. As illustrated in FIG. 6, attribute 612 is derived from attribute 610 and 612, and attributed 614 is derived from attribute 612. Likewise, attribute 626 is derived from attribute 622 and attribute 628 is derived from attribute 628. Each set of data can also include one or more metric calculations based on attribute data, such as metrics 616, 618 for source 602 and metrics 630 and 632 for source 604.

In an illustrative embodiment, the mapping of attributes from the source data can correspond to the original source data format that does not require transformation. Additionally, in an illustrative embodiment, one or more attributes may be derived from the source data. Further, in an illustrative embodiment the process of identification of attributes and metrics for each data source can be repeated for the number of data sources to be processing. One skilled in the relevant art will appreciate that the number of data sources, number of attributes, relationship between attributes and the number of metrics are illustrative in nature and should not be construed as limiting.

Returning to FIG. 5, at block 508, the data processing application 202 aligns the attributes and merges metrics. In an illustrative embodiment, the alignment of attributes corresponds to the identification of similar, or like, attributes from different data sources. In one aspect, the alignment of attributes can correspond to the identification of substantially similar attributes having different field labels or identifiers. In another aspect, the alignment of attributes can correspond to the association of different attributes that can be grouped together for purposes of a particular data analysis. In an illustrative embodiment, the merging of metrics can correspond to the collection of metrics from the various data sources. At block 510, the routine 500 terminates.

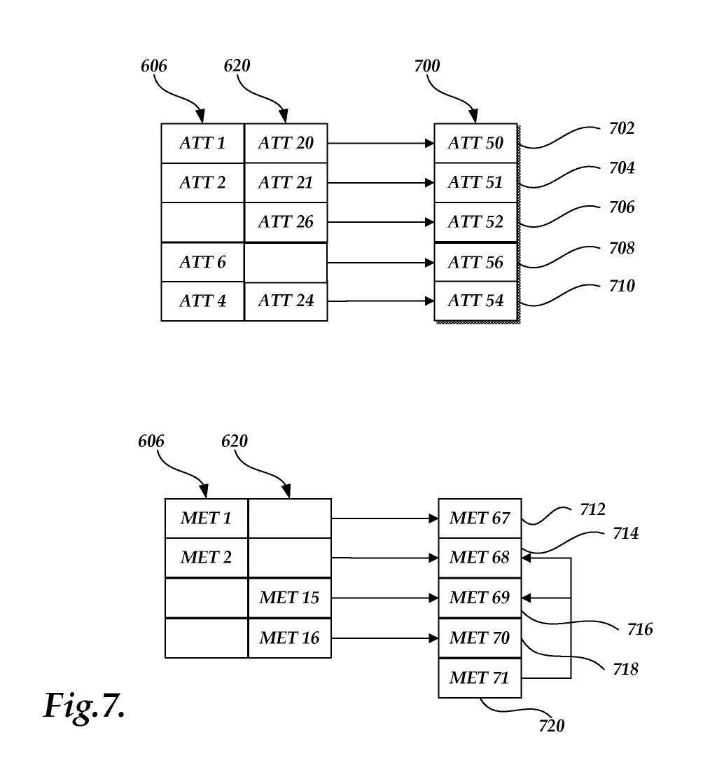

With reference now to FIG. 7, a block diagram illustrating the alignment of data attributes and merging of metrics to generate a pool of attributes and data metrics in accordance with an aspect of the present invention will be described. As illustrated in FIG. 7, each set of data 606, 620 can be illustrated as separate columns for purposes of comparison. Within each column, data attributes can be aligned by association of a row across the columns, 606, 620. The resulting alignment is embodied as a set of aligned attributes 700 including attributes 702-710. For example, attribute 702 includes the resulting alignment of “ATT 1” and “ATT 20,” which were determined to be similar for purposes of this multi-dimensional data set. Attribute 706 was only determined to include “ATT 26” as no attribute from column 602 was determined to be alignable with the attribute from column 620. As also illustrated in FIG. 7, the resulting merged metrics includes a set of metrics 712-718 which are based on the columns 606, 620, respectively. Additionally, metric 702 can be derived from metric 716 and 718, which corresponds to metrics calculated from the two data sources 602, 604.

Turning now to FIG. 8, a flow diagram illustrative of a data query processing routine 800 will be described. At block 802, the data processing application 202 obtains a data query. In an illustrative embodiment, the data query can be submitted by the interface component 208 and can include a variety of information utilized to determine a resulting data set from the source data. The interface component 208 can utilize a variety of manners for obtaining the data query including application interfaces or other protocols to facilitate interaction with other software applications, various user interfaces for obtaining data query information from users, and a combination thereof. At block 804, the data processing application returns a resulting data set from the user query. In an illustrative embodiment, the data processing application 202, and any additional data processing engines, generates the resulting data set by processing the source data according to the data definitions generated previously (e.g., routine 500) and then applying the data query criteria. Alternatively, some portion of the source data may be previously processed. In an illustrative embodiment, the interface application 208 may provide additional processing for the display of the set of data, such as formatting and display processing.

At block 806, the interface application 208 can define a resulting drill path from the resulting data set. In an illustrative embodiment, the drill path is generated by the interface application 208 to facilitate the viewing/further processing of the set of data. The drill path information may be presented in a graphical form, such as in a user interface. The drill path information can correspond to a logical organization of the set of attributes 700 (FIG. 7) and does not modify the source data. At block 808, the data processing application can obtain a revised data query based on the drill path. Based on the revised data query, the routine 800 returns to block 804. In an illustrative embodiment, the revised data query can correspond to additional attributes and metrics that have not been previously defined. If so, the data processing application 202 may implement routine 500 again to obtain new definitions.

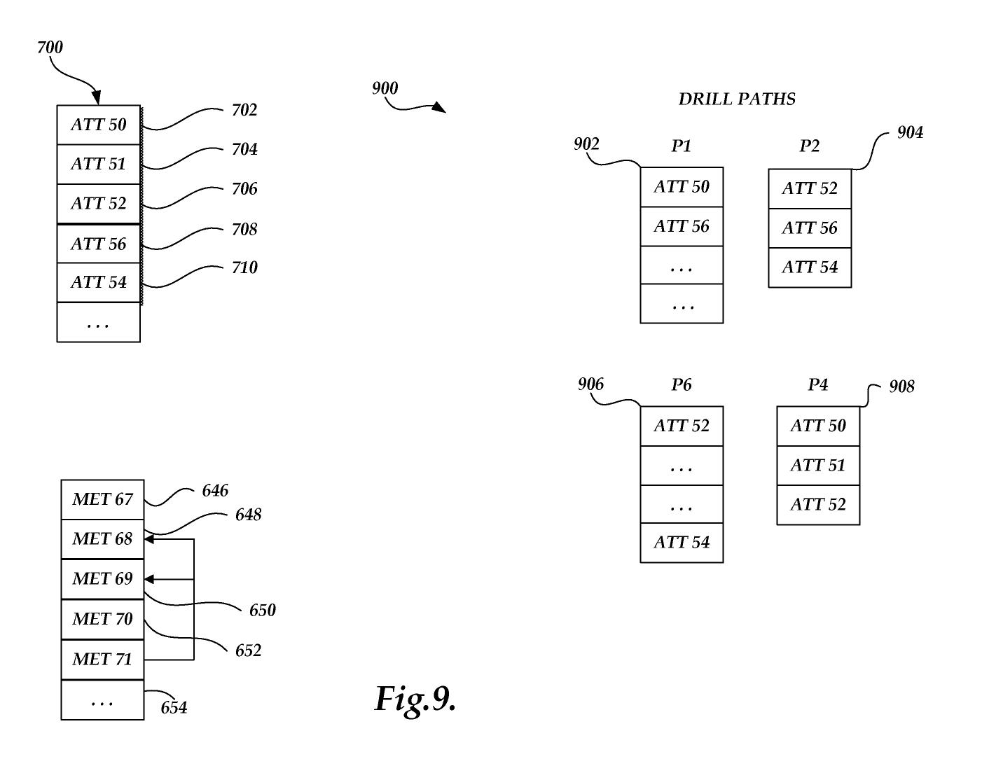

With reference now to FIG. 9, a block diagram 900 illustrating the generation of drill paths in accordance with an aspect of the present invention will be described. As illustrated in FIG. 9, the set of drill paths, 902, 904, 906, and 908 correspond to various attributes from the set of attributes 700. The drill paths 902-908 are logical and can include any one of a variety of attributes. Any drill path can be modified according to additional data query requirements without modifying the underlying source data. Additionally, as described above, the set of attributes 700 may be modified based on additional information required for a modified data query.

While illustrative embodiments have been illustrated and described, it will be appreciated that various changes can be made therein without departing from the spirit and scope of the invention.

1. A method for managing data comprising:
obtaining a set of source data, wherein the source data corresponds to a native format;
identifying a set of data requirements;
defining a set of data definitions corresponding to the processing of the source data to obtain the set of data requirements; and
storing the set of data definitions.

2. The method as recited in claim 1, wherein the set of data requirements corresponds to a multi-dimensional data structure.

3. The method as recited in claim 1, wherein defining the set of data requirements corresponds to defining a set of data definitions for each data source in the set of source data.

4. The method as recited in claim 1, wherein defining the set of data definitions includes aligning data attributes.

5. The method as recited in claim 4, wherein aligning data attributes includes aligning similar data attributes.

6. The method as recited in claim 4, wherein aligning data attributes includes grouping unsimilar data attributes.

7. The method as recited in claim 1, wherein defining the set of data definitions includes deriving one or more data attributes.

8. The method as recited in claim 1, wherein defining the set of data definitions includes merging metrics.

9. The method as recited in claim 8, wherein defining the set of data definitions includes deriving metrics from a set of merged metrics.

10. A computer-readable medium having computer-executable components for data management comprising:
an interface for obtaining a set of data sources, wherein the set of data sources, wherein the source data corresponds to a native format;
a data processing component for identifying a set of data requirements and processing of the source data to obtain the set of data requirements; and
a second interface for obtaining data queries for the processed source data.

11. A method for managing data comprising:
obtaining a set of source data, wherein the source data corresponds to a native format;
identifying a set of data requirements;
defining a set of data definitions corresponding to the processing of the source data to obtain the set of data requirements;
obtaining a data query;
providing a set of data corresponding to the data query;
obtaining a revised data query based on drill paths.

12. The method as recited in claim 11 further comprising identifying a modified set of data definitions based on the revised data query.
